(19) United States
(12) Patent Application Publication
(10) Pub. No.: US 2012/0014033 A1
(43) Pub. Date: Jan. 19, 2012

(54) Static electricity eliminator

(75) Inventor: Hai-Pin KUO, Tainan (TW)

(73) Assignee: Sports Art Industrial Co., Ltd.

(21) Appl. No.: 12/804,077

(22) Filed: Jul. 13, 2010

(51) Int. Cl. H05F 3/00

(52) U.S. Cl. 361/220

(57) ABSTRACT

A static electricity eliminator includes a clip device for attaching to a user, an adaptor for attaching to an object, and an electric cable coupled between the clip device and the adaptor for transmitting a static electricity from the user to the object and for suitably reducing or eliminating a static electricity from the user and for preventing the result of static electricity buildup and discharge from being occurred on the user, the clip device includes two pivotal levers having a jaw member at one end and a hand grip member at another end, the adaptor includes a cover mounted to a housing and electrically coupled to the electric cable, and includes one or more magnetic members for attracting to the object.

### BACKGROUND OF THE INVENTION

1. Field of the Invention

The present invention relates to a static electricity eliminator, and more particularly to a static electricity eliminator including a structure for easily and readily attaching or coupling or connecting a user to an object, such as a treadmill or other exercising mechanisms, and for suitably reducing or eliminating a static electricity from the user and for preventing the result of static electricity buildup and discharge from being generated or occurred on the user.

2. Description of the Prior Art

Typical static electricity eliminators have been developed and provided for reducing static electricity and for suitably reducing or eliminating a static electricity from the user and for preventing the result of static electricity buildup and discharge from being generated or occurred on the user, particularly at the fuel stations, or around the fuel dispensers.

For example, U.S. Pat. No. 7,558,044 to George et al. discloses one of the typical static electricity eliminators comprising an ionizer for generating ions for neutralizing static electricity, a blower for producing a current of air for moving the ions to a desired location, and a motion detector operatively connected to the blower.

However, the static electricity on the user may not be suitably removed or reduced or eliminated and may also be built up and discharged from the user.

For the users of various exercising mechanisms, such as the treadmill, the static electricity may be easily built up and discharged from the user such that the exercisers may easily experience the static electricity discharge problem.

However, no static electricity eliminators have been developed and provided for reducing static electricity and for suitably reducing or eliminating the static electricity from the users or the exercisers of the exercising mechanisms.

The present invention has arisen to mitigate and/or obviate the afore-described disadvantages of the conventional static electricity eliminators.

### SUMMARY OF THE INVENTION

The primary objective of the present invention is to provide a static electricity eliminator including a structure for easily and readily attaching or coupling or connecting a user to an object, such as a treadmill or other exercising mechanisms, and for suitably reducing or eliminating a static electricity from the user and for preventing the result of static electricity buildup and discharge from being generated or occurred on the user.

In accordance with one aspect of the invention, there is provided a static electricity eliminator comprising a clip device for attaching to a user, an adaptor for attaching to an object, and an electric cable coupled between the clip device and the adaptor for transmitting a static electricity from the user to the object and for preventing the result of static electricity buildup and discharge from being generated or occurred on the user.

The clip device includes two levers having a middle portion pivotally coupled together with a pivot axle, and each having a jaw member provided at one end therein, and each having a hand grip member provided at another end for actuating the jaw members to engage with the user or to be disengaged from the user.

The clip device includes a spring biasing member anchored and retained between the hand grip members of the levers for biasing and forcing the jaw members toward each other and for biasing and forcing the jaw members to engage with the user or to be attached onto the user.

The clip device includes a fence extended from each of the hand grip members for engaging with the spring biasing member and for anchoring and retaining the spring biasing member between the hand grip members of the levers and for preventing the spring biasing member from being disengaged from the hand grip members.

The clip device includes a pole extended from one of the hand grip members for engaging with the spring biasing member and for further anchoring and retaining the spring biasing member between the hand grip members of the levers and for preventing the spring biasing member from being disengaged from the hand grip members. The clip device includes an opening formed in one of the hand grip members for receiving or engaging with one end of the electric cable.

The adaptor includes a housing and includes a cover mounted to the housing and electrically coupled to the electric cable. The housing includes a chamber formed therein, and includes an orifice formed therein and communicative with the chamber of the housing for receiving one end of the electric cable which is electrically coupled to the cover.

The housing includes a compartment formed therein, and includes at least one magnetic member received in the compartment of the housing for attracting or attaching or mounting or securing the housing to various objects. The housing includes a metal panel received in the compartment of the housing, and/or contacted or engaged with the magnetic member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a static electricity eliminator in accordance with the present invention;

FIG. 2 is a partial cross sectional view of the clip device of the static electricity eliminator;

FIG. 3 is a partial perspective view illustrating the operation or the attachment of the static electricity eliminator to a facility or object; and

FIG. 4 is another partial perspective view illustrating the operation or the attachment of the static electricity eliminator to a user.

### DETAILED DESCRIPTION OF THE PREFERRED EMBODIMENT

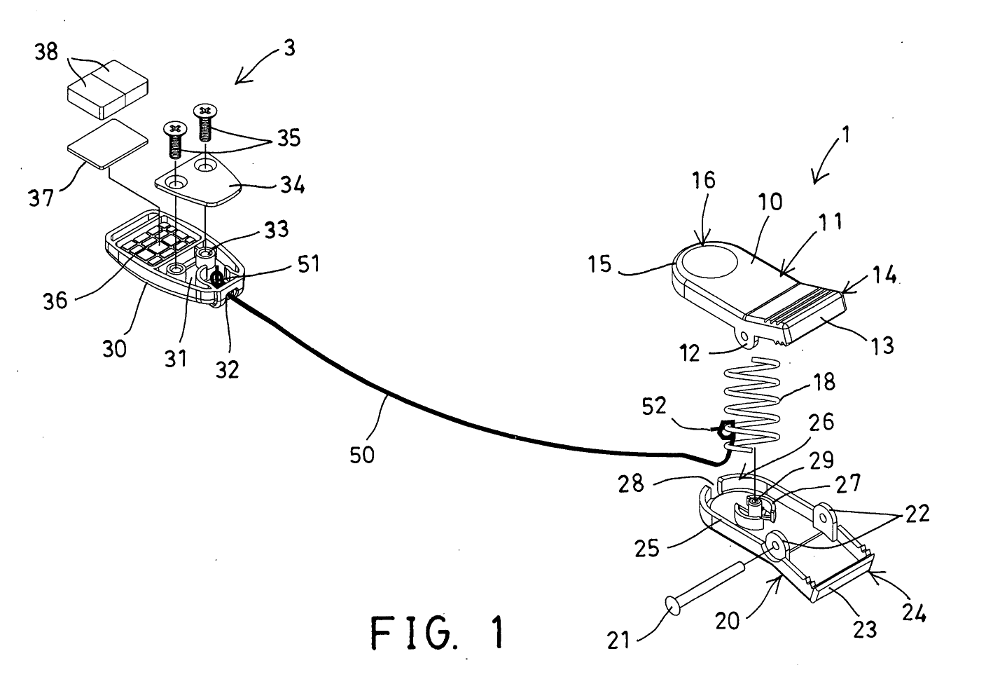

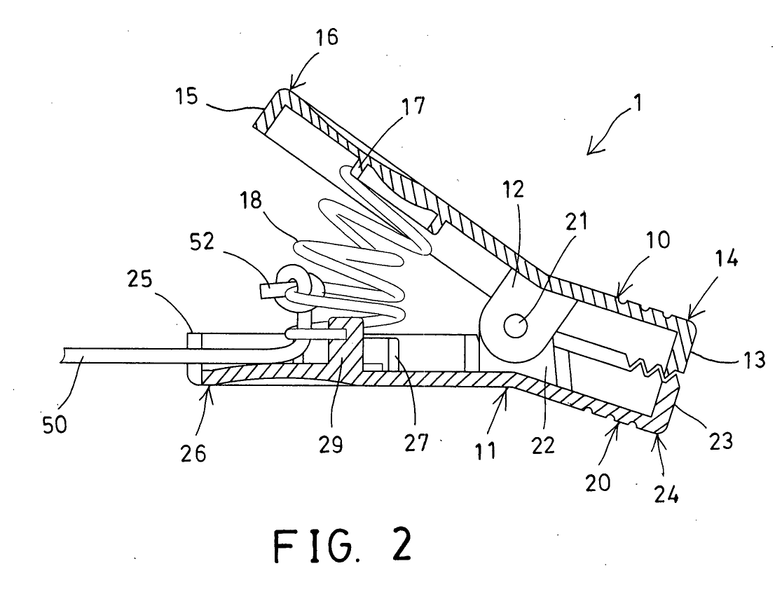

Referring to the drawings, and initially to FIGS. 1 and 2, a static electricity eliminator in accordance with the present invention comprises a clip device 1 including two arms or levers 10, 20 having a middle portion 11 pivotally or rotatably coupled together with a pivot axle 21, for example, the levers 10, 20 each include one or more (such as two) ears 12, 22 extended from the middle portion 11 thereof for engaging with the pivot axle 21 and for pivotally or rotatably coupling the middle portions 11 of the levers 10, 20 together and for allowing the jaw member 13, 23 at the one end 14, 24 of the levers 10, 20 to be pivoted or moved toward or away from each other, and also for allowing the hand grip member 15, 25 at the other end 16, 26 of the levers 10, 20 to be pivoted or moved toward or away from each other.

The levers 10, 20 each further include a peripheral or circular fence 17, 27 extended therefrom, such as extended from the hand grip member 15, 25 thereof for engaging with a spring biasing member 18 and for anchoring or positioning or retaining the spring biasing member 18 between the hand grip member 15, 25 of the levers 10, 20, and thus for allowing the jaw members 13, 23 of the levers 10, 20 to be biased or forced toward each other with the spring biasing member 18. The lever 20 includes a notch or opening 28 formed therein (FIG. 1), such as formed in the hand grip member 25 thereof, and includes a pole 29 extended therefrom, such as extended from the hand grip member 25 thereof, and extended in the fence 27 for further engaging with the spring biasing member 18 and for further anchoring or positioning or retaining the spring biasing member 18 between the hand grip member 15, 25 of the levers 10, 20.

The static electricity eliminator further comprises an attaching or mounting device or an adaptor 3 including a housing 30 having a chamber 31 formed therein, and including an orifice 32 formed therein and communicative with the chamber 31 of the housing 30 for receiving an electric wire or cable 50 and for allowing the one end 51 of the electric cable 50 to be engaged into the chamber 31 of the housing 30, the other end 52 of the electric cable 50 is extended or engaged into or through the opening 28 of the lever 20 and electrically coupled or connected to the spring biasing member 18 which is also electrically coupled or connected to the levers 10, 20, in which the levers 10, 20 may be made of conductive plastic or metal materials.

The housing 30 includes one or more (such as two) studs 33 extended therein, and a conductive plastic or metal plate or cover 34 is attached or mounted or secured to the housing 30 with one or more (such as two) fasteners 35 which may be engaged with the studs 33 for attaching or mounting or anchoring or positioning or retaining or securing the cover 34 to the housing 30 and for suitably blocking or enclosing or shielding the chamber 31 of the housing 30. The one end 51 of the electric cable 50 is electrically coupled or connected to the conductive cover 34. The housing 30 further includes a compartment 36 formed therein for receiving a conductive plastic or metal plate or panel 37 and/or one or more magnetic members 38 which may be used for attracting or attaching or mounting or securing the housing 30 to various objects 80, such as the treadmill 80 or other exercising mechanisms 80.

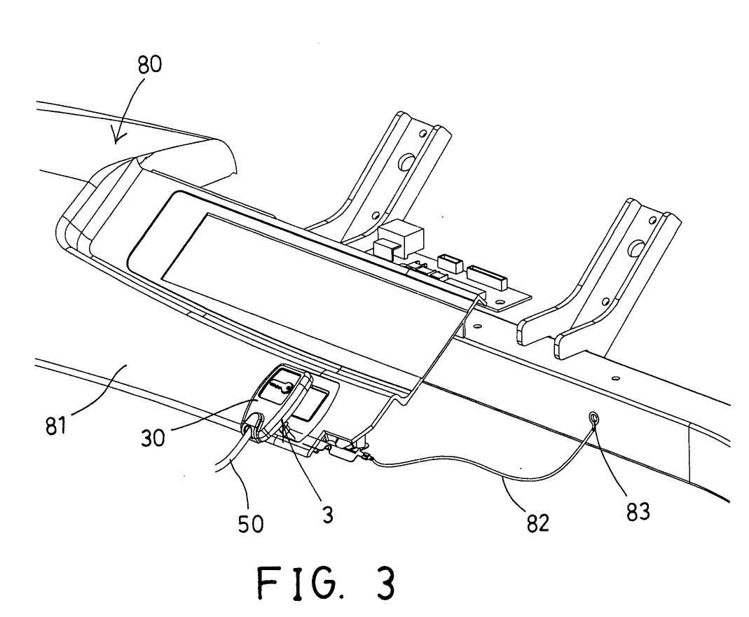

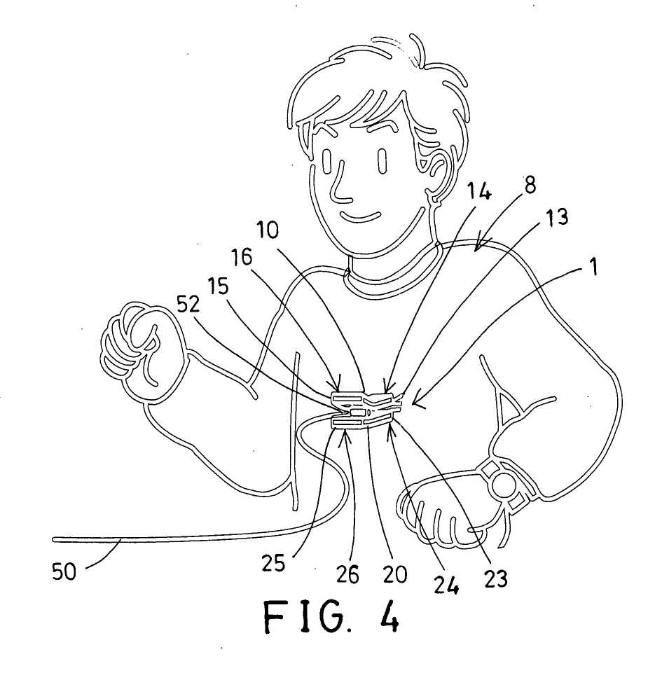

In operation, as shown in FIG. 3, the magnetic members 38 may be used for easily and readily attracting or attaching or mounting or securing the housing 30 to various objects 80, such as the handle 81 of the treadmill 80, which includes a ground lead or cable or wire 82 electrically coupled or connected to the ground terminal 83 for discharging the static electricity. As shown in FIG. 4, the clip device 1 may be used for easily and readily attracting or attaching or mounting or securing to the user 8 for allowing the static electricity to be transmitted from the user 8 to the handle 81 of the treadmill 80 and then to the ground terminal 83 for discharging the static electricity and for preventing the result of static electricity buildup and discharge from being generated or occurred on the user, and the hand grip members 15, 25 may be provided for actuating the jaw members 13, 23 to engage with the user 8 or to be disengaged from the user 8.

Accordingly, the static electricity eliminator in accordance with the present invention includes a structure for easily and readily attaching or coupling or connecting a user to an object, such as a treadmill or other exercising mechanisms, and for suitably reducing or eliminating a static electricity from the user and for preventing the result of static electricity buildup and discharge from being generated or occurred on the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A static electricity eliminator comprising:
a clip device for attaching to a user,
an adaptor for attaching to an object, and
an electric cable coupled between said clip device and said adaptor for transmitting a static electricity from the user to the object.

2. The static electricity eliminator as claimed in claim 1, wherein said clip device includes two levers having a middle portion pivotally coupled together with a pivot axle, and each having a jaw member provided at one end therein, and each having a hand grip member provided at another end.

3. The static electricity eliminator as claimed in claim 2, wherein said clip device includes a spring biasing member anchored and retained between said hand grip members of said levers for biasing and forcing said jaw members toward each other.

4. The static electricity eliminator as claimed in claim 3, wherein said clip device includes a fence extended from each of said hand grip members for engaging with said spring biasing member and for anchoring and retaining said spring biasing member between said hand grip members of said levers.

5. The static electricity eliminator as claimed in claim 3, wherein said clip device includes a pole extended from one of said hand grip members for engaging with said spring biasing member.

6. The static electricity eliminator as claimed in claim 2, wherein said clip device includes an opening formed in one of said hand grip members for receiving one end of said electric cable.

7. The static electricity eliminator as claimed in claim 1, wherein said adaptor includes a housing, and a cover mounted to said housing and electrically coupled to said electric cable.

8. The static electricity eliminator as claimed in claim 7, wherein said housing includes a chamber formed therein, and includes an orifice formed therein and communicative with said chamber of said housing for receiving one end of said electric cable which is electrically coupled to said cover.

9. The static electricity eliminator as claimed in claim 7, wherein said housing includes a compartment formed therein, and includes at least one magnetic member received in said compartment of said housing.

10. The static electricity eliminator as claimed in claim 9, wherein said housing includes a metal panel received in said compartment of said housing.
